(19) United States
(12) Patent Application Publication
(10) Pub. No.: US 2025/0294217 A1
(43) Pub. Date: Sep. 18, 2025

(54) User Engagement

(71) Applicant: Angel Studios, Inc., Provo, UT (US)

(72) Inventors: Seth Taylor, Provo, UT (US); Ajay Madhok, Provo, UT (US)

(21) Appl. No.: 19/219,809

(22) Filed: May 27, 2025

Related U.S. Application Data
(63) Continuation of application No. 18/076,371, filed on Dec. 6, 2022, now abandoned.
(60) Provisional application No. 63/286,118, filed on Dec. 6, 2021.

(51) Int. Cl. H04N 21/472; H04N 21/4788

(52) U.S. Cl. CPC H04N 21/472; H04N 21/4788

(57) ABSTRACT

A user interface may comprise a timeline associated with media content wherein the timeline shows both a measure of a consumer reaction to the media content at a first time on the timeline and a measure of the consumer reaction to the media content at a second time on the timeline. The timeline may comprise a visual wave effect.

### CROSS REFERENCE TO RELATED APPLICATIONS

This application is a continuation of and claims priority to U.S. Nonprovisional application Ser. No. 18/076,371, which was filed on Dec. 6, 2022, is titled “User Engagement,” and the first inventor of which is Seth Taylor, and which is incorporated by reference in its entirety. application Ser. No. 18/076,371 claims priority to U.S. Provisional Application No. 63/286,118, which was filed on Dec. 6, 2021, and which is incorporated by reference in its entirety.

### BACKGROUND OF THE INVENTION

Digital Content is ubiquitous. Notwithstanding the ubiquity, it is often expensive and non-trivial to create and distribute quality Digital Content. Many conventional/legacy methods for financing creation and distribution of have been employed—with mixed results. Some forms of contemporary Digital Content may be amenable to conventional/legacy monetization schemes. But many, by nature, are not.

What is need is new, improved, and more effective methods of and systems for engaging users in consumption of, use of, and interaction(s) with Digital Content.

### BRIEF SUMMARY OF THE INVENTION

Improved methods of and systems for engaging users may include providing interfaces and back-end support for a Scene-centric paradigm, i.e., “liking” interacting, with, sharing, and using Digital Content on a Scene level. This may include commenting on Scenes and/or having a system for managing Scenes according to a user's preferences or characterizations.

Another embodiment may comprise user interfaces and back-end support for user engagement through creating, or contributing to creation of, Remixes of Scenes. A Remix may be any user-guided alteration of the Digital Content comprising a Scene to create the Remix. Some examples include altering sound, substituting speech, altering visual elements, altering spatial layout, altering character features, adding annotations or commentary, changing color scheme properties, etc.

### BRIEF DESCRIPTION OF THE DRAWINGS

FIG. 1 illustrates an exemplary user interface for user engagement as disclosed herein.

FIG. 2 illustrates an exemplary user interface for user engagement as disclosed herein.

FIG. 3 illustrates an exemplary user interface for user engagement as disclosed herein.

FIG. 4 illustrates an exemplary user interface for user engagement as disclosed herein.

FIG. 5 illustrates an exemplary user interface for user engagement as disclosed herein.

FIG. 6 illustrates an exemplary user interface for user engagement as disclosed herein.

FIG. 6 illustrates an exemplary user interface for user engagement as disclosed herein.

FIG. 7 illustrates an exemplary user interface for user engagement as disclosed herein.

FIG. 8 illustrates an exemplary user interface for user engagement as disclosed herein.

### DETAILED DESCRIPTION OF THE INVENTION

This application claims priority to U.S. Provisional Application No. 63/286,118, titled “User Engagement,” and filed on Dec. 6, 2021, and which is incorporated herein by reference in its entirety.

A system and method are disclosed for improved user engagement with Digital Content.

Table of Reference Numbers from Drawings:

The following table is for convenience only and should not be construed to supersede any potentially inconsistent disclosure herein.

| Reference | |
|---|---|
| Number | Description |
| 100 | device |
| 200 | interface |
| 201 | digital content |
| 202 | “likes” |
| 203 | favorite storage |
| 204 | like wave |
| 205 | like statistic |
| 206 | saved like |
| 210 | remix |
| 211 | edit |
| 212 | share |
| 213 | comment |
| 214 | cancel |
| 215 | recommended formats |
| 216 | edit recommendations |
| 220 | recommended friends |
| 221 | share methods |

### Definitions

Digital—data requiring a perception apparatus for human perception; capable of being stored in a manner that is amenable to perfect reproduction.

Electronic—as used herein, interchangeable with Digital.

Digital Content 201—Audiovisual content, visual content, audio content, or any other content that is amenable to electronic (or similar) presentation through a screen, projection, speakers, or other presentation devices/technologies known in the art; and which is additionally amenable to storage and transmission on digital/electronic storage and/or transmission media.

Digital Asset—A protectable (legally, digitally, or otherwise) right in a discrete set of Digital data, wherein the right is amenable to independent (of any other Digital data) beneficial use.

User Interface 200—Any electronic interface for (i) presenting digital content, e.g., smartphone, laptop, tablet, television, speaker, projector, etc. and/or (ii) receiving input and/or data from a user, e.g., touch screen, keyboard, mouse, microphone, accelerometer, gyroscope, camera, haptic sensing, etc.

Like 202—commonly used term for identifying a positive response/experience/sentiment relationship from a user/consumer toward specific digital content. For example, as is well known, many social media platforms provide an interface and/or scheme where a user may “like” a post, image, video, or other content.

Remix 210—a Remix to a Scene is a customized and/or personalized edit to a Scene. A Remix may include, but is not limited to, overlaid text, overlaid visual image or effect, overlaid video, visual cropping, audio cropping, slowing down or speeding up a scene, adding custom audio, adding custom video, replacing a scene character's face with the face of a user or another, or other user-guided or user-influenced alternation to a Scene.

Scene broadly refers to any segment of digital content. For example, conventionally a Scene may be a temporally defined segment of audio-visual, visual, or audio content. In a broader sense, a Scene may be any subset of digital content. For example, a Scene may be multiple temporal segments (e.g., 1:21-3:33, 7:19-8:14, and 10:07-11:13), or the audio track (or a portion of the audio track) for some or all of digital content, or a visual subset (e.g., a top portion of a screen or display), or a subset of audio (e.g., a frequency filter, or talking but not music, etc.).

### “Liking” a Scene

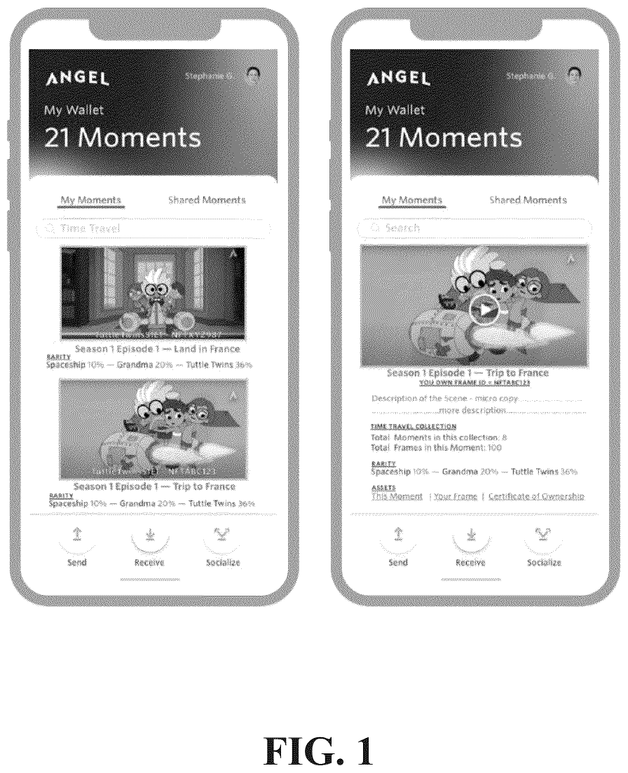

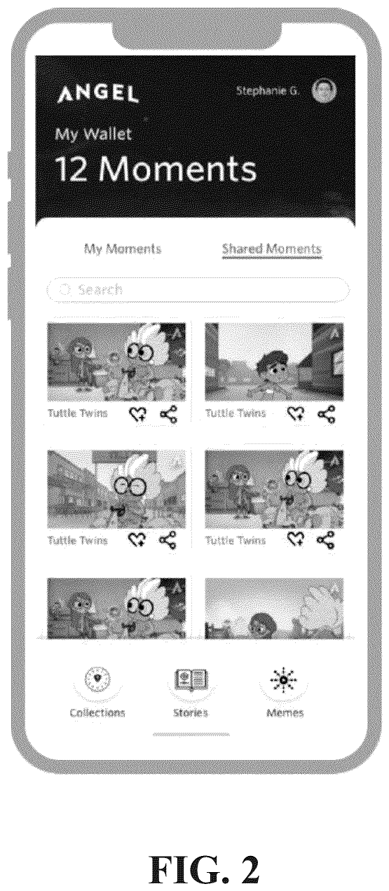

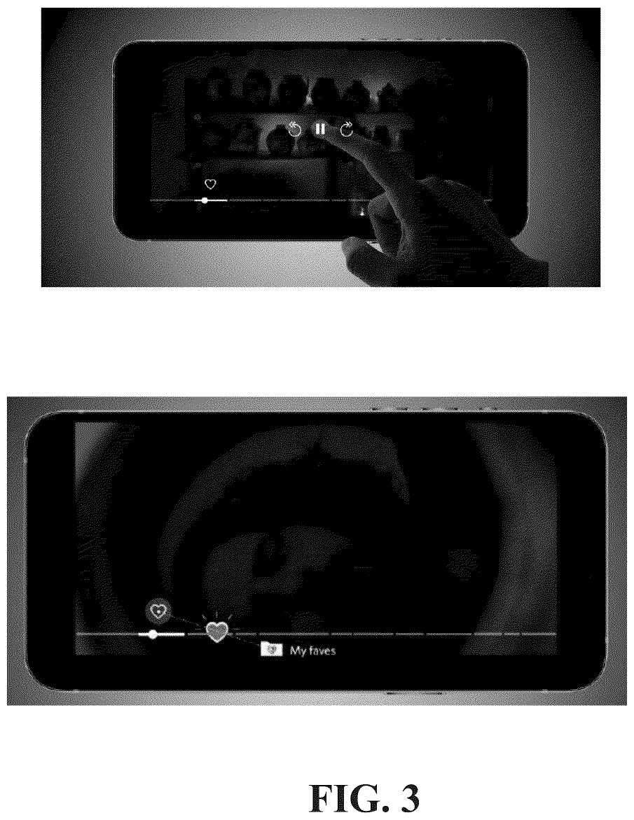

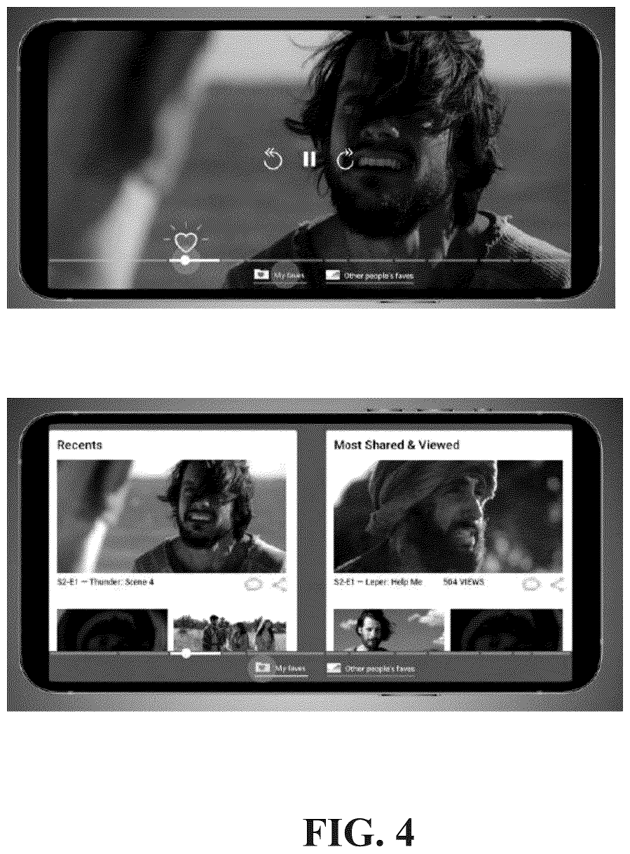

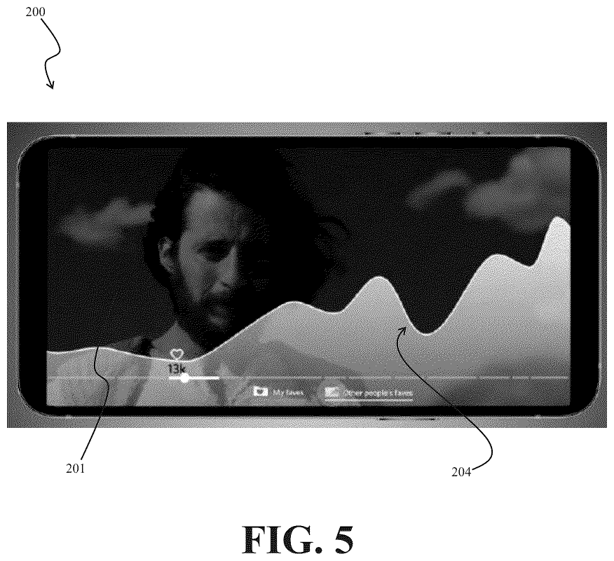

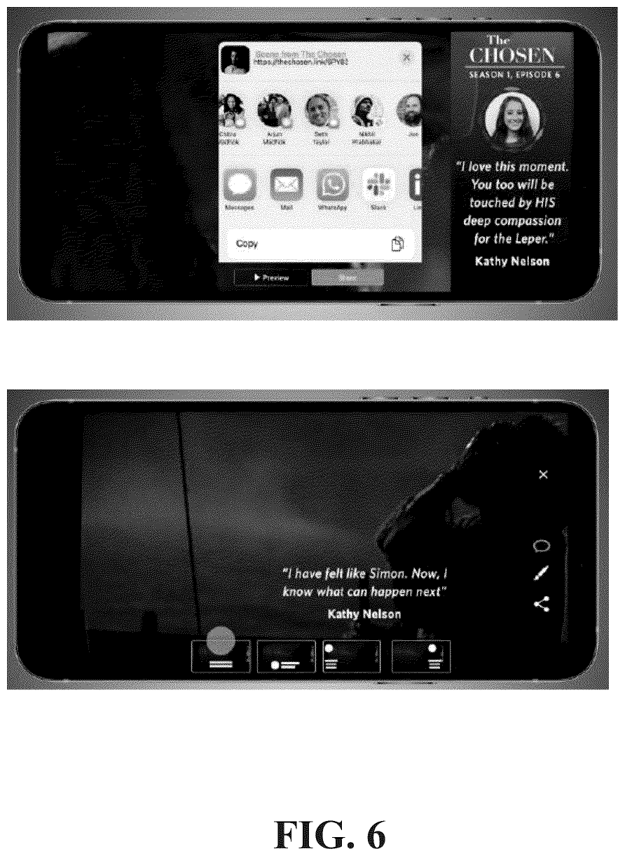

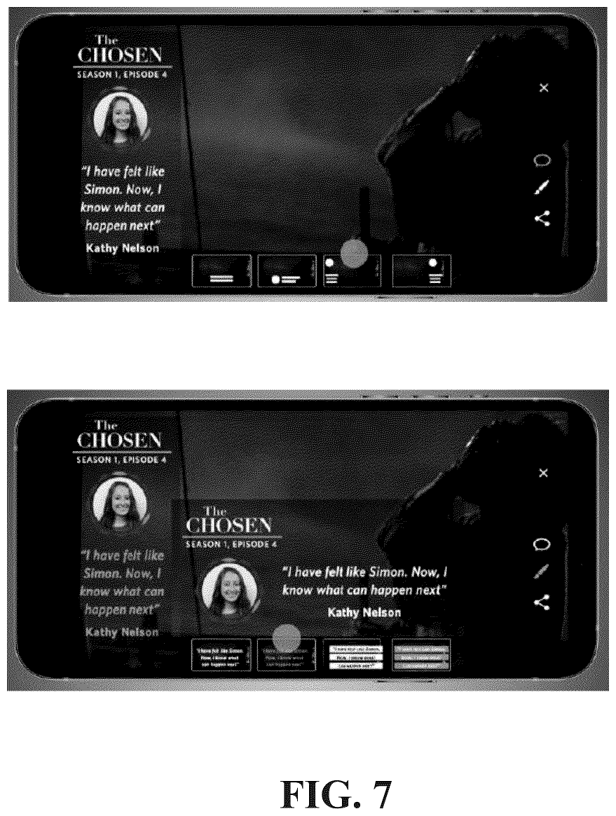

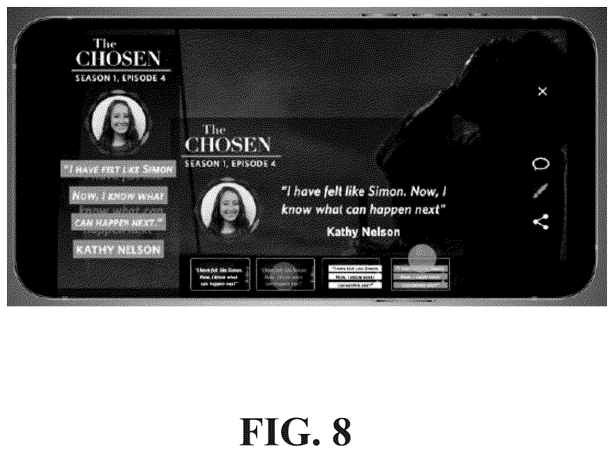

A user interface 200 may present controls and/or prompts to a user to “like” a Scene. In some embodiments, a Scene may be predefined. In some embodiments, a user may define a Scene, e.g., by selecting a temporal beginning and temporal end to identify a Scene from audiovisual digital content. A user interface 200 for “liking” 202 may comprise haptically selecting a “thumbs up symbol,” “heart symbol,” or other symbol; speaking a word or other audio signal; shaking a smartphone, or any other user input technology. For example, in one embodiment a user may be watching audiovisual content on his/her smartphone, e.g., a movie. When the user taps the screen with his/her finger, a visual interface may appear that may provide a visual control, e.g., a heart, by which a user may indicate a desire to “like” a current Scene, as shown in FIG. 1d. An additional control or visual indicator may inform a user as to the scope of the Scene, or may allow the user to define his/her own custom Scene.

When a user “likes” a Scene, such “like” 202 may be stored either locally on the presentation device or remotely on a server.

In one embodiment, a presentation device may provide an indication to a user that a user has previously “liked” 202 one or more Scenes from digital content 201, as illustrated in FIGS. 1e-g.

In one embodiment, a presentation device 100 may provide to a user a representation (visual or otherwise) of the number or percentage of other users that have “liked” 202 a Scene, or may provide a representation of “like statistics” 205 per Scene. This “like” 202 information may be stored on a digital meta-content server.

In one embodiment, a presentation device 100 may show a timeline that marks/identifies one or more scenes and indicates a number of likes 205 for one or more or the Scenes. The number of likes 205 for a Scene may be the number of likes 205 across all users, or across a subset of users. The number of likes 205 for a Scene may also reflect the number of likes 205 over a specific time period, or in a recent time period. A chronological (e.g., a timeline) visualization of likes by Scenes may be referred to as a “like wave” 204. This presentation may be illustrated by FIG. 1h, wherein a “like wave” 204 is shown in front of digital content 201.

### “Liked” Scenes Management

In one embodiment, a presentation device 100 may present a visualization of a user's “liked” 202 Scenes. This may be through a folder paradigm 203 (e.g., a “liked” scenes folder) or through any other interface for showing a set of “liked” Scenes. Scenes may also be sorted/filtered/visualized by other characteristics, e.g., emotional, happy, well-done, etc. See FIG. 1g.

### Commenting on a Scene

In one embodiment, a presentation device 100 provides an interface 200 through which a user may comment 213 on, leave a hashtag for, or otherwise annotate a scene. This may be referred to as Scene-level commenting.

### Favorites

In one embodiment, a presentation device 100 may provide an interface 200 through which a user may rank Scene “likes” 202. In one embodiment, a user may indicate, through the user interface, that a “like” 202 is a favorite. Many schemes may be employed to rank or characterize “likes” 202, e.g., characterizing some “likes” as favorites, indicating a “like” rating on a scale of 1-10, or any other way or scheme for characterizing the level of a “like.”

In one embodiment, the presentation device 100 may provide an interface 200 through which a user may manage his/her “likes” 202, e.g., a folder system 203, or sorting or filtering system, or other organization system.

In one embodiment, a user may annotate a “liked” 202 or favorited scene. An annotation may comprise a text note, an image, a sound pattern, or any other digital content 201 that may provide some commentary, message or noteworthy information associated with the “liked”/favorited 202 scene.

### Sharing Favorites

The presentation device 100 may present to a user an interface 200 through which a user may share 212 one or more favorites over various channels 221, e.g., social media, email, messaging, or other networking/association platforms or schemes.

In one embodiment, the presentation device 100 may suggest connections 222 with whom to share one or more favorites. For example, the presentation device 100 may suggest a connection that has “liked” 202 or favorited similar Scenes or content, or who has previously reacted positively to shares or Scenes comprising similar content, or connections with whom a user frequently interacts or communicates.

### Scene Remix

In one embodiment, the presentation device 100 may provide an interface through which a user may create a “remix” 210 of a “liked” 202, favorited, or otherwise identified Scene.

A remix 210 of a Scene may comprise an annotation or derivative of the Scene in a manner that may reflect a customization of the Scene for a user or that may otherwise be meaningful for a user.

Exemplary remixes 210 include, but are not limited to: altering coloring of a Scene; altering positioning of a Scene; showing a profile image superimposed on or otherwise with the Scene; altering the spatial layout and/or positioning of the Scene and/or elements in the Scene; customized soundtrack or background music; adjusting the background music, sound, or soundtrack; substituting speech with the user's voice or with another's voice, or mixing speech with another's voice; substituting one or more words with different words in the user's voice or in another's voice (for example, the original actor could do a voiceover with a user's name); adjusting the visual background or setting of a Scene to be a user's house or some other setting/background that may be meaningful to a user; adding visual text, e.g., something that the user may find meaningful or that may be a commentary or reaction to the scene; slowing down or speeding up some or all of the Scene; cropping some or all of the Scene; changing a street sign to be a street sign that may be recognizable to a user or that may have some significance for a user; substituting a user's (or another's) face or other body features for the face or body features of an actor in the Scene; superimposing a visual element such as a user's pet or personal property over some or all of a Scene; including audio, visual, and/or audiovisual commentary or narration; cartoonizing or sketchizing or doodlizing (or some other effect) some or all of the Scene; adjusting coloring of some or all of the Scene; and/or adjusting sound features or characteristics (e.g., frequency, volume, etc.) of the Scene.

A Remix 210 may also include pins, flags, or other identifiers for identifying noteworthy elements (audio, visual, audiovisual, or otherwise) of a scene. Such identifiers may be audio, visual, audiovisual, or any other indication that may be conveyed to another user. Such noteworthy elements may be elements that are intended for discussion, or about which a user has a question, or which a user desires to identify for himself/herself or for another user.

In one embodiment, creating a Remix 210 (or contributing to a Remix) may comprise answering a question or prompt about a Scene. Responses from one or multiple users/viewers may be aggregated to generate an annotation for a Scene. Such annotation may be presented visually or otherwise, with the Scene or in conjunction with the Scene.

### Discussing a Scene

In one embodiment, the presentation device 100 may provide an interface 200 through which one or more users may engage in an interaction, e.g., “discuss” or “converse about” a Scene. Such a “conversation” may be associated with the Scene as a whole, or a segment or portion of the Scene, or an element of the Scene, or a flag/identifier for an element of a Scene. A conversation may be text, video, audio, audiovisual, or any other means for conversing, interacting, or sharing about a scene.

### Treasure a Scene

In some embodiments, a user may be able to purchase, own, manage, and/or otherwise have rights in all of or a portion of a Scene or Digital Content related to a scene.

Such rights may include some or all of the following, or a combination of some or all of the following: rights to generate specific Remixes 210 of a Scene; rights to share and/or sell Remixes 210, rights to allow others to make Remixes 210 of a Scene; rights to sublicense these rights; rights to financially benefit from Remixes 210 or otherwise from a Scene; rights to promote a Scene; rights to use a Scene to promote a good or service; rights to select soundtrack or other audio features that will be used for other users; rights to post the image online or in other ways or platforms; rights to use the Digital Content 201 in conjunction with a personal profile or online presence or social media presence; access to metadata about a Scene or Digital Content 201 (metadata may include, but is not limited to, title, frame ID, tags, a rarity score/explanation/metric); and rights to create, use, and/or publicize variants of characters in a

### Scene or in Digital Content.

Such rights may be managed, memorialized, documented, and/or evidenced by, e.g., non-fungible tokens or a similar scheme for rights management.

What is claimed is:

1. A method, comprising:
providing an interface comprising a timeline associated with media content, wherein the timeline shows both (i) a first measure of a consumer reaction to the media content at a first time on the timeline; and (ii) a second measure of the consumer reaction to the media content at a second time on the timeline.

2. The method of claim 1, wherein the consumer reaction is a positive reaction.

3. The method of claim 1, wherein the consumer reaction is a like.

4. The method of claim 1, wherein the interface provides both (i) a first number of the consumer reactions at the first time on the timeline; and (ii) a second number of the consumer reactions at the second time on the timeline.

5. The method of claim 1, wherein the interface provides a wave visual effect.
